(19) United States
(12) Patent Application Publication
(10) Pub. No.: US 2015/0120146 A1
(43) Pub. Date: Apr. 30, 2015

(54) APPARATUS AND METHOD FOR ADJUSTING MONITORING AREA OF REMOTE MONITOR

(71) Applicant: Hyundai Motor Company, Seoul (KR)

(72) Inventors: Myung Seon HEO, Seoul (KR); Young Chul OH, Seongnam-si (KR)

(73) Assignee: HYUNDAI MOTOR COMPANY, Seoul (KR)

(21) Appl. No.: 14/285,758

(22) Filed: May 23, 2014

(30) Foreign Application Priority Data
Oct. 25, 2013 (KR) 10-2013-0127840

(51) Int. Cl. G01S 17/02; B60W 40/06

(52) U.S. Cl. CPC G01S 17/02; B60W 40/06
USPC 701/45

(57) ABSTRACT

An apparatus for adjusting a monitoring area of a remote monitor according to the present disclosure comprises a storage for storing a viewing angle and an irradiation angle of the remote monitor depending on a type of a road. A road determiner determines the type of the road on which a vehicle drives. A controller searches the viewing angle and the irradiation angle corresponding to the type of the road determined by the road determiner in the storage. A viewing angle adjuster sets the viewing angle searched by the controller as a reference viewing angle. An irradiation angle adjuster sets the irradiation angle searched by the controller as a reference irradiation angle.

### CROSS-REFERENCE TO RELATED APPLICATION

This application is based on and claims the benefit of priority to Korean Patent Application No. 10-2013-0127840, filed on Oct. 25, 2013 in the Korean Intellectual Property Office, the disclosure of which is incorporated herein in its entirety by reference.

### TECHNICAL FIELD

The present disclosure relates an apparatus and a method for adjusting a monitoring area of a remote monitor, more particularly, a technology for adjusting a monitoring area of a remote monitor mounted on a vehicle according a type of a driving road.

### BACKGROUND

Recently, more vehicles are provided with light detection and ranging (LiDAR). On the basis of information obtained from the LiDAR mounted on a vehicle, an electronic controller of the vehicle can calculate a distance, a relative speed and angle between an object near the vehicle and the vehicle.

The vehicle having the LiDAR can provide various safe functions and convenient functions by calculating the distance, the relative speed and angle, etc. between the object near the vehicle and the vehicle. For example, anti-collision function during move/stop, smart cruise function on moving, or automatic parking function can be achieved by using information input from the LiDAR mounted on the vehicle and identifying the distance, the relative speed or angle between the object near the vehicle and the vehicle.

Since the LiDAR is important in order to provide a driver with the various safe functions and convenient functions, reliability of the information input from the LiDAR is also important. However, the conventional LiDAR has a fixed monitoring area, and thus, the monitoring ability varies depending on the type of the road.

### SUMMARY

An aspect of the present disclosure provides a monitoring area adjusting apparatus and a method capable of enhancing monitoring ability of a remote monitor by determining a type of a road on which a vehicle drives and then adjusting the monitoring area of the remote monitor.

According to an exemplary embodiment of the present disclosure, an apparatus for adjusting a monitoring area of a remote monitor comprises a storage for storing a viewing angle and an irradiation angle of the remote monitor depending on a type of a road. A road determiner determines the type of the road on which a vehicle drives. A controller searches the viewing angle and the irradiation angle corresponding to the type of the road determined by the road determiner in the storage. A viewing angle adjuster sets the viewing angle searched by the controller as a reference viewing angle. An irradiation angle adjuster sets the irradiation angle searched by the controller as a reference irradiation angle.

According to another exemplary embodiment of the present disclosure, an apparatus for adjusting a monitoring area of a remote monitor comprises a storage for storing a viewing angle and an irradiation angle of the remote monitor depending on a type of a road. A navigation interworker collects road information on which a vehicle drives. A controller searches the viewing angle and the irradiation angle corresponding to the road information collected by the navigation interworker in the storage. A viewing angle adjuster sets the viewing angle searched by the controller as a reference viewing angle. An irradiation angle adjuster sets the irradiation angle searched by the controller as a reference irradiation angle.
According to another exemplary embodiment of the present disclosure, a method for adjusting a monitoring area of a remote monitor is provided. The method comprises storing a viewing angle and an irradiation angle of the remote monitor depending on a type of a road by a storage. The type of the road on which a vehicle drives is determined by a road determiner. The viewing angle and the irradiation angle corresponding to the determined type of the road in the storage are searched by a controller. The viewing angle searched by the controller is set as a reference viewing angle by a viewing angle adjuster. The irradiation angle searched by the controller is set as a reference irradiation angle by an irradiation angle adjuster.

As the above described, the present disclosure determines the type of the road on which the vehicle drives and then adjusts the monitoring area of the remote monitor mounted on the vehicle, thereby enhancing the monitoring ability of the remote monitor.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of an embodiment for a monitoring area adjusting apparatus of a remote monitor according to the present disclosure.

FIG. 2A is an exemplary diagram for a remote monitoring area set by a monitoring area adjusting apparatus according to the present disclosure.

FIG. 2B is an exemplary diagram for a local monitoring area set by a monitoring area adjusting apparatus according to the present disclosure.

FIG. 2C is an exemplary diagram for remote and local monitoring areas set by a monitoring area adjusting apparatus according to the present disclosure.

FIG. 3 is a flowchart of an embodiment for a monitoring area adjusting method of a remote monitor according to the present disclosure

### DETAILED DESCRIPTION

Hereinafter, with reference to the accompanying drawings, exemplary embodiments according to the present disclosure will be described in detail.

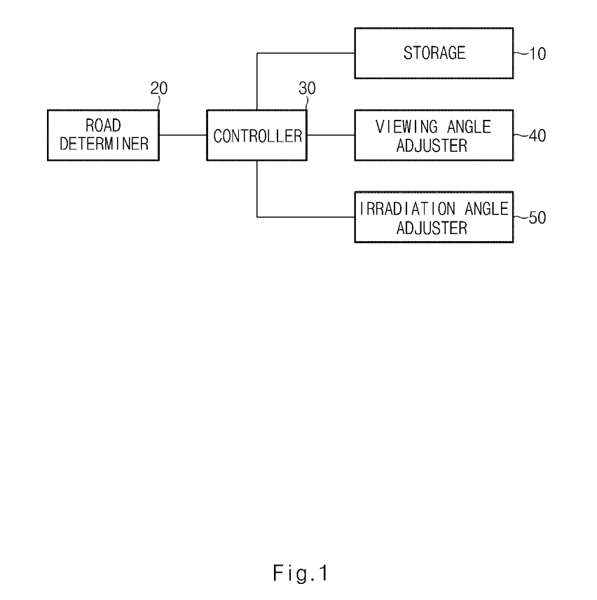

FIG. 1 is a configuration diagram of an embodiment for a monitoring area adjusting apparatus of a remote monitor according to the present disclosure. As shown in FIG. 1, the monitoring area adjusting apparatus of the remote monitor includes a storage 10, a road determiner 20, a controller 30, a viewing angle adjuster 40, and an irradiation angle adjuster 50.

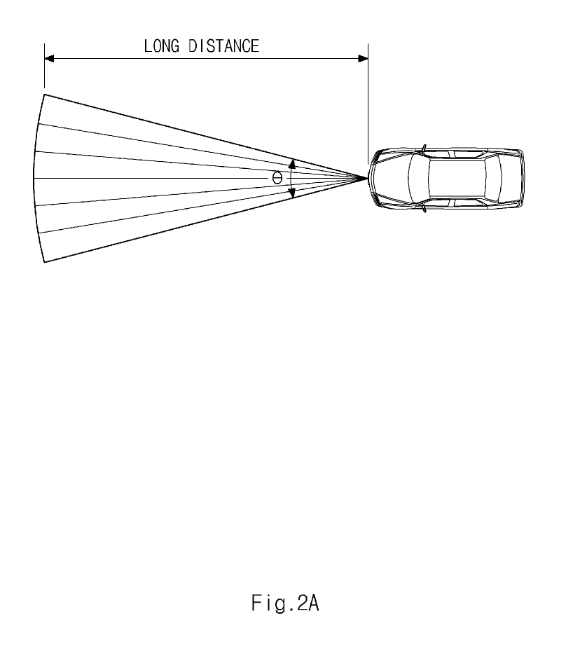

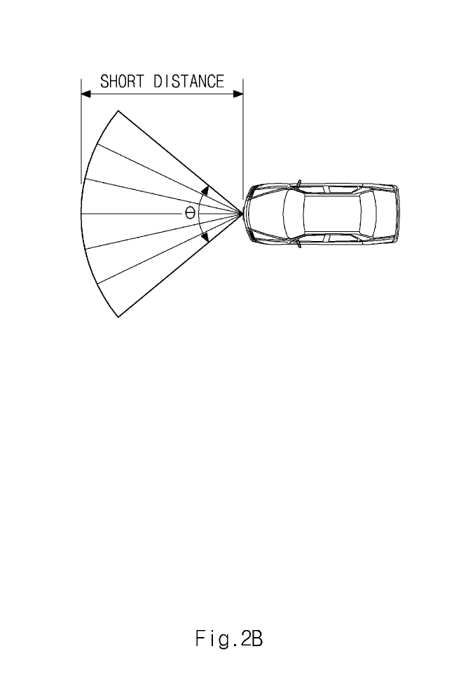

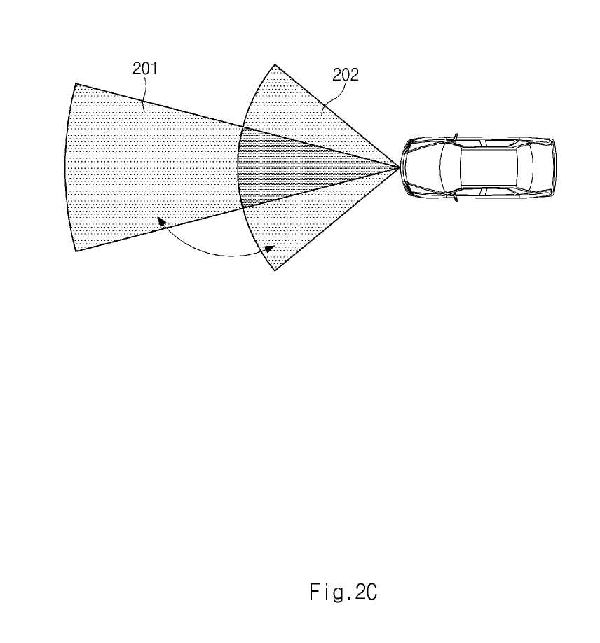

The storage 10 stores a table which records a viewing angle (FOV: Field Of View) and an irradiation angle of the remote monitor depending on a type of a road. For example, as shown in FIG. 2A, for a highway, a first viewing angle (θ) and a first irradiation angle for monitoring a remote area are stored. As shown in FIG. 2B, for a city road, a second viewing angle (θ) and a second irradiation angle for monitoring a local area are stored. At this time, the first viewing angle is smaller than the second viewing angle, and the first irradiation angle is equal to or smaller than the second irradiation angle. At this time, as the irradiation angle is smaller, the resolution is higher.

Here, the irradiation angle means an angle between irradiating beams within the viewing angle. For example, if the viewing angle is 100 degrees, and the irradiation angle is 1 degree, it means irradiating one hundred beams. That is, as the irradiation angle is smaller, it is possible to detect a farther object.

Next, the road determiner 20 determines the type of the current driving road as one of a highway and city road based on driving information of the vehicle. At this time, the driving information includes a speed, a steering angle, yaw rate, etc. In other words, the road determiner 20 determines the type of the driving road as the highway if the speed of the vehicle exceeds 60 km/h, and the steering angle does not exceed a threshold range, and as the city road if the speed of the vehicle does not exceeds 60 km/h, and the steering angle exceeds the threshold range.

The road determiner 20 can also determine the type of the current driving road as one of the highway and city road based on the monitoring result of the remote monitor. That is, the road determiner 20 can determine whether it is the highway or the city road by detecting guard rails, median barriers, speeds of the neighboring vehicles, people, bicycles, motorcycles, the neighboring building, etc.

Also, the road determiner 20 can determine the type of the current driving road as one of the highway and city road based on the driving information and of the vehicle and the monitoring result of the remote monitor. At this time, generally known neural network technology is utilized.

The road determiner 20 includes road information database (not shown), determiner (not shown), and the like. The road information database stores acceleration/deceleration periods for each type of the road, average vehicle speeds for each road, acceleration/deceleration times for each road, and the like.

If the vehicle is driven at a constant high speed in the highway, the acceleration/deceleration periods are 5-10 minutes, which is relatively long, and there are many transitions of acceleration and deceleration in the city road, the acceleration/deceleration periods are around 30 seconds-1 minute. Also, while the average speeds are more than 80 km/h and 60 km/h for each highway, the average speeds are 30 km/h and 20 km/h or so for each city road. The acceleration/deceleration times for each road decrease in order of the highway and the city road. The road determiner 20 can detect the average speed and determine the type of the road by comparing the detected average speed with previously stored average speed for each road. The road determiner 20 can detect the acceleration and deceleration sizes and determine the type of the road by comparing the detected acceleration and deceleration sizes with previously stored acceleration and deceleration sizes for each road.

Next, the controller 30 performs an overall control, so that each of the above components normally operates respective functions. In particular, the controller 30 searches the corresponding viewing angle and the corresponding irradiation angle in the storage 10 according to the type of the road determined by the road determiner 20. That is, if the road the vehicle drives is the highway, the controller 30 searches the corresponding first viewing angle and first irradiation angle and then transfers it to the viewing angle adjuster 40 and the irradiation angle adjuster 50 respectively, thereby controlling the remote monitor to monitor the remote monitoring area as shown in FIG. 2A.

Also, if the road is the city road, the controller 30 searches the corresponding second viewing angle and second irradiation angle and then transfers it to the viewing angle adjuster 40 and the irradiation angle adjuster 50 respectively, thereby controlling the remote monitor to monitor the local monitoring area as shown in FIG. 2B.

Finally, as shown in FIG. 2C, if the driving road is the highway depending on the type of the road, the viewing angle and the irradiation angle are adjusted to monitor the remote monitoring area 201. If the driving road is the city road, the viewing angle and the irradiation angle are adjusted to monitor the local monitoring area 202.

The viewing adjuster 40 sets the viewing angle transferred from the controller 30 as a reference viewing angle. In other words, the range, which a beam is irradiated, is set on the basis of the viewing angle transferred from the controller 30. For example, if the viewing angle is 30 degrees, the angle of the area monitored by the remote monitor becomes 30 degrees.

Next, the irradiation adjuster 50 sets the irradiation angle transferred from the controller 30 as a reference irradiation angle. In other words, the angle, which a beam is irradiated, is set on the basis of the irradiation angle transferred from the controller 30. For example, if the irradiation angle is 1, the remote monitoring irradiates the beam at intervals of 1 degree.

Additionally, the present disclosure further comprises a navigation interworker (not shown), and can collect road information which the vehicle currently drives through navigation information (map information, positioning information). An example of the remote monitor according to the present disclosure includes LiDAR, RADAR, etc.

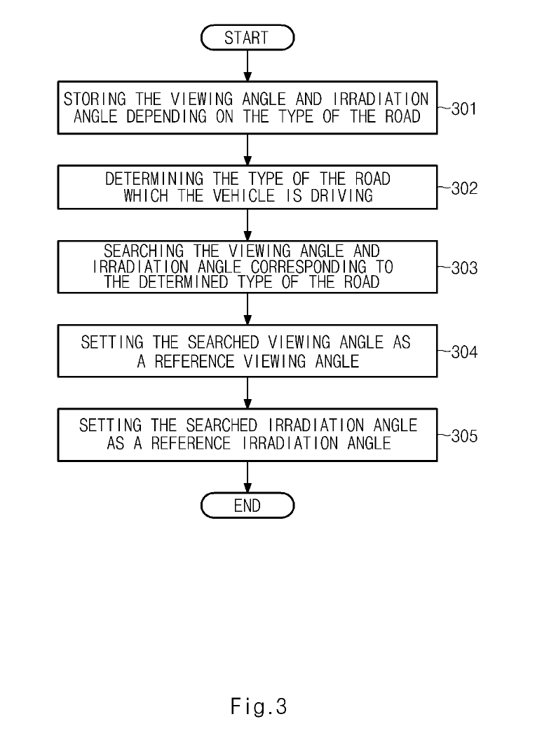

FIG. 3 is a flowchart of an embodiment for a monitoring area adjusting method of a remote monitor according to the present disclosure.

First, the storage 10 stores the viewing angle and the irradiation angle of the remote monitor depending on the type of the road (301). Then, the road determiner 20 determines the type of the road which the vehicle currently drives (302). Then, the controller 30 searches the viewing angle and the irradiation angle determined by the road determiner 20 in the storage 10 (303). The viewing angle adjuster 40 sets the viewing angle searched by the controller 30 as a reference viewing angle (304). The irradiation angle adjuster 50 sets the irradiation angle searched by the controller 30 as a reference irradiation angle (305). By these processes, the monitoring ability of the remote monitor can be improved.

It should be interpreted that the scope of the present disclosure is defined by the following claims rather than the above-mentioned detailed description and all modifications or alterations deduced from the meaning, the scope, and equivalences of the claims are included in the scope of the present disclosure.

What is claimed is:

1. An apparatus for adjusting a monitoring area of a remote monitor comprising:
a storage for storing a viewing angle and an irradiation angle of the remote monitor depending on a type of a road;
a road determiner for determining the type of the road on which a vehicle drives;
a controller for searching the viewing angle and the irradiation angle corresponding to the type of the road determined by the road determiner in the storage;
a viewing angle adjuster for setting the viewing angle searched by the controller as a reference viewing angle; and
an irradiation angle adjuster for setting the irradiation angle searched by the controller as a reference irradiation angle.

2. An apparatus for adjusting a monitoring area of claim 1, wherein the controller searches a first viewing angle and a first irradiation angle if the road on which the vehicle drives is a highway, and searches a second viewing angle and a second irradiation angle if the road on which the vehicle drives is a city road.

3. An apparatus for adjusting a monitoring area of claim 2, wherein the first viewing angle is smaller than the second viewing angle, and the first irradiation angle is equal to or smaller than the second irradiation angle.

4. An apparatus for adjusting a monitoring area of claim 1, wherein the road determiner determines the type of the road based on driving information of the vehicle.

5. An apparatus for adjusting a monitoring area of claim 4, wherein the driving information is at least one of a speed, a steering angle, and yaw rate.

6. An apparatus for adjusting a monitoring area of claim 1, wherein the road determiner determines the type of the road based on a monitoring result of the remote monitor.

7. An apparatus for adjusting a monitoring area of a remote monitor comprising:
a storage for storing a viewing angle and an irradiation angle of the remote monitor depending on a type of a road;
a navigation interworker for collecting road information on which a vehicle drives;
a controller for searching the viewing angle and the irradiation angle corresponding to the road information collected by the navigation interworker in the storage;
a viewing angle adjuster for setting the viewing angle searched by the controller as a reference viewing angle; and
an irradiation angle adjuster for setting the irradiation angle searched by the controller as a reference irradiation angle.

8. An apparatus for adjusting a monitoring area of claim 7, wherein the controller searches a first viewing angle and a first irradiation angle if the road on which the vehicle drives is a highway, and searches a second viewing angle and a second irradiation angle if the road on which the vehicle drives is a city road.

9. An apparatus for adjusting a monitoring area of claim 8, wherein the first viewing angle is smaller than the second viewing angle, and the first irradiation angle is equal to or smaller than the second irradiation angle.

10. An method for adjusting a monitoring area of a remote monitor comprising steps of:
storing a viewing angle and an irradiation angle of the remote monitor depending on a type of a road by a storage;
determining the type of the road on which a vehicle drives by a road determiner;
searching the viewing angle and the irradiation angle corresponding to the determined type of the road in the storage by a controller;
setting the viewing angle searched by the controller as a reference viewing angle by a viewing angle adjuster; and
setting the irradiation angle searched by the controller as a reference irradiation angle by a irradiation angle adjuster.

11. An method for adjusting a monitoring area of claim 10, wherein the step of searching includes steps of searching a first viewing angle and a first irradiation angle if the road on which the vehicle drives is a highway, and searching a second viewing angle and a second irradiation angle if the road on which the vehicle drives is a city road.

12. An method for adjusting a monitoring area of claim 11, wherein the first viewing angle is smaller than the second viewing angle, and the first irradiation angle is equal to or smaller than the second irradiation angle.
